(19) United States
(12) Patent Application Publication
(10) Pub. No.: US 2025/0045749 A1
(43) Pub. Date: Feb. 6, 2025

(54) SYSTEMS AND METHODS FOR GENERATING A DIGITAL TOKEN SLIP

(71) Applicant: Wells Fargo Bank, N.A., San Francisco, CA (US)

(72) Inventor: Mangaiyarkarasi Sivakolunthu, Chennai (IN)

(73) Assignee: Wells Fargo Bank, N.A., San Francisco, CA (US)

(21) Appl. No.: 18/230,057

(22) Filed: Aug. 3, 2023

(51) Int. Cl. G06Q 20/40

(52) U.S. Cl. CPC G06Q 20/401

(57) ABSTRACT

Systems and methods for requesting, generating, and processing digital tokens are disclosed. A system can receive, from a first user device associated with a first user, a first request to generate a digital token representing a transfer of a resource to a second user. Upon verifying authentication information received from the first user device, the system generates the digital token for transmission to the second user device. The digital token is associated with a usage timestamp. The system receives, from a transaction machine, a second request to redeem the digital token, the second request designating a portion of the resource. Responsive to determining that the second request to redeem the digital token is valid, the system causes the transaction machine to provide the portion of the resource, and credits a remainder of the resource to an account associated with the second user.

### FIELD OF THE DISCLOSURE

The present invention relates generally to the field of tokenized information.

### BACKGROUND

Post-dated payments are conventionally implemented using checks, or similar payment instruments. However, post-dated checks are easily lost, forged, or fraudulently modified, potentially resulting in delayed access to funds from financial institutions. Due to these issues, such payment instruments are often associated with longer processing times.

### SUMMARY

The systems and methods described herein provide digital tokens that may be used as surrogates for post-dated payments between users. As the generation and provision of digital token slips is performed via a computing system of a provider institution, the disadvantages of post-dated checks or similar payment instruments cannot occur, because digital tokens cannot be fraudulently created or modified. Tokenization of information improves security by replacing sensitive information, such as payment information, with a unique identifier. Even if the token is intercepted or stolen, it cannot be used to gain access to the information for which the token was generated, improving the overall security of the system. Due to this increased security, the digital tokens described herein may be utilized to immediate credit an account or dispense cash represented by the digital token, as along as all authentication procedures corresponding to the digital token have been met.

At least one aspect of the present disclosure is directed to a system. The system includes a provider institution computing system comprising one or more processors and at least one non-transitory memory. The system can receive, from a first user device associated with a first user, a first request to generate a digital token representing a transfer of a resource to a second user. The first request comprises an identifier of a second user device associated with the second user. The system can generate the digital token for transmission to the second user device upon verifying authentication information received from the first user device. The digital token is associated with a usage timestamp. The system can receive, from a transaction machine associated with the provider institution computing system, a second request to redeem the digital token, the second request designating a portion of the resource. Responsive to determining that the second request to redeem the digital token is valid, the system can cause the transaction machine to provide the portion of the resource. The system can credit a remainder of the resource to an account associated with the second user.

In some implementations, the authentication information includes an authentication code. In some implementations, the system can generate the authentication code in response to the first request, and transmit the authentication code to the second user device. In some implementations, the system can determine that the second request to redeem the digital token is valid based on a comparison of a current time to the usage timestamp. In some implementations, the transaction machine includes an automated teller machine (ATM), and the system can receive, from the ATM associated with the provider institution computing system, a third request to redeem a second digital token, the second digital token associated with a second usage timestamp, and transmit, to the ATM for display, an error message responsive to determining that the second digital token is not valid based on the second usage timestamp.

In some implementations, the system can generate a second authentication code for transmission to the second user device in response to receiving the second request, and verify the second request to redeem the digital token based on the second authentication code and a message received from the transaction machine. In some implementations, the system can authenticate the second user based on biometric information provided via the transaction machine. In some implementations, the system can identify the account associated with the second user based on the identifier of the second user device of the second user.

In some implementations, the transaction machine includes an ATM, and the system can cause the ATM to dispense the portion of the resource responsive to determining that the second request to redeem the digital token is valid. In some implementations, the digital token is associated with an expiration timestamp, and the system can determine that the digital token is valid based on a current timestamp being prior to the expiration timestamp. In some implementations, the system comprises a digital token database including a mapping between the digital token and the transfer of the resource from the first user to the second user.

At least one other aspect of the present disclosure is directed to a non-transitory computer-readable medium with instructions embodied thereon that, when executed by one or more processors of a provider institution computing system of a provider institution, cause the one or more processors to perform operations. The operations include receiving, from a first user device associated with a first user, a first request to generate a digital token representing a transfer of a resource to a second user. The first request comprises an identifier of a second user device associated with the second user. The operations include generating the digital token for transmission to the second user device upon verifying authentication information received from the first user device. The digital token is associated with a usage timestamp. The operations include receiving, from a transaction machine associated with the provider institution computing system, a second request to redeem the digital token, the second request designating a portion of the resource. The operations include causing the transaction machine to provide the portion of the resource responsive to determining that the second request to redeem the digital token is valid. The operations include crediting a remainder of the resource to an account associated with the second user.

In some implementations, the operations include transmitting a request for biometric data to the second user device, receiving, responsive to the request for biometric data, biometric information of the second user from the second user device, and authenticating the second user based on the biometric information. In some implementations, the operations include determining that the second request to redeem the digital token is valid is responsive to authenticating the second user.

In some implementations, the authentication information comprises an authentication code. In some implementations, the operations include generating the authentication code in response to the first request, and transmitting the authentication code to the second user device. In some implementations, the operations include receiving, from the transaction machine associated with the provider institution computing system, a third request to redeem a second digital token. In some implementations, the second digital token is associated with a second usage timestamp.

In some implementations, the operations include determining that the second digital token is not valid based on the second usage timestamp, and transmitting, to the transaction machine for display, an error message responsive to determining that the second digital token is not valid based on the second usage timestamp. In some implementations, the third request comprises second biometric data of the second user. In some implementations, the operations include determining that the third request is not valid based on the second biometric data of the second user, and transmitting, to the transaction machine for display, an error message responsive to determining that the third request is not valid.

Yet another aspect of the present disclosure is directed to a method. The method may be performed, for example, by at least one computing system. The method includes receiving, from a first user device associated with a first user, a first request to generate a digital token representing a transfer of a resource to a second user. The first request comprises an identifier of a second user device associated with the second user. The method includes generating the digital token for transmission to the second user device upon verifying authentication information received from the first user device. The digital token is associated with a usage timestamp. The method includes receiving, from a transaction machine associated with the at least one computing system, a second request to redeem the digital token. The second request designates a portion of the resource. The method includes causing the transaction machine to provide the portion of the resource responsive to determining that the second request to redeem the digital token is valid. The method includes crediting a remainder of the resource to an account associated with the second user.

In some implementations, the authentication information includes an authentication code. The method includes generating the authentication code in response to the first request, and transmitting the authentication code to the second user device. In some implementations, determining that the second request to redeem the digital token is valid is further based on a comparison of a current time to the usage timestamp.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations, and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ may be interpreted as including one or more referents unless the context clearly dictates otherwise.

### BRIEF DESCRIPTION OF THE DRAWINGS

FIG. 1 is a block diagram depicting an example environment for requesting, generating, and processing digital tokens, in accordance with one or more implementations.

FIGS. 2A, 2B, and 2C are diagrams showing example graphical user interfaces for requesting a digital token, in accordance with one or more implementations.

FIGS. 3A, 3B, and 3C are diagrams showing example graphical user interfaces for processing a digital token, in accordance with one or more implementations.

FIG. 4 is a flowchart of an example method of requesting, generating, and processing digital tokens, in accordance with one or more implementations.

### DETAILED DESCRIPTION

Referring to the figures generally, various systems, apparatuses, and methods requesting, generating, and processing digital tokens are described herein. The digital tokens described herein may be generated to represent post-dated transfers of resources, which may include any type of transfer including the transfer of money or information. In response to a corresponding request, the system described herein generates the digital token to represent the transfer of the resource from a sender to the recipient. Various authentication techniques may be used to verify both the sender and the receiver when generating or processing the digital token for the transfer. Authentication techniques may include biometric authentication techniques, two-factor authentication techniques, or contactless device authentication, among others. When processing the digital token to perform the post-dated transfer of the resource, the validity of the digital token and the time period in which it is processed may be verified. In some implementations, redeeming the resource may include providing a portion of the resource directly to the recipient, and crediting the remaining portion of the resource to an account of the recipient.

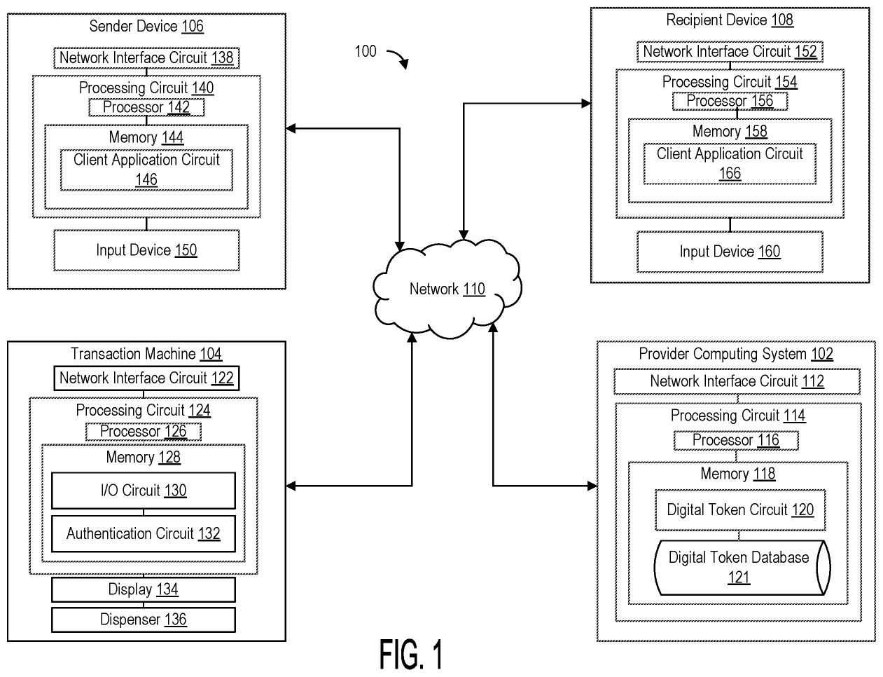

Advantageously, the systems and methods described herein solve various security issues resulting from conventional post-dated resource transfers. Conventional approaches typically utilize mechanisms for post-dated transfers that are easily modified or fraudulently created. In contrast, the systems and methods described herein generate surrogate values that, on their own, provide no benefit to a fraudulent actor, because the digital token itself does not include any sensitive information that can be used to access the resource it protects. Instead, the authentication procedures described herein prevent fraudulent actors from accessing and processing a digital token without approval from the recipient or the sender. Therefore, the systems and methods described herein provide technical improvements to the security of resource transfer systems, and in particular, resource transfer systems that operate to carry out post-dated transfers of resources.

| Referring to FIG. 1, a block diagram of an example environment 100 for requesting, generating, and processing digital tokens is shown. As shown, the environment 100 includes a provider computing system 102 communicably and operatively coupled with a transaction machine 104, a sender device 106, and a recipient device 108 over a network 110. The network 110 provides communicable and operative coupling between provider computing system 102, the transaction machine 104, the sender device 106, and the recipient device 108, and other components disclosed and described herein to provide and facilitate the exchange of communications (e.g., data, instructions, messages, values, commands). Accordingly, the network 110 may include any network including wired (e.g., Ethernet) and/or wireless networks (e.g., 802.11X, ZigBee, Bluetooth, WiFi). In some arrangements, the network 110 includes the Internet. In further embodiments, the network 110 includes a proprietary banking network to provide secure or substantially secure communications.

The provider computing system 102 is operated by a provider, which is an entity that facilitates various types of post-dated transfers initiated or processed by the sender device 106, the transaction machine 104, the recipient device 108, and various other entities not explicitly described or shown herein. In some embodiments, the provider computing system 104 may be the computing system associated with a provider institution, such as a financial institution, that provides financial services (e.g., demand deposit accounts, credit accounts, etc.) to customers, and may thus be a financial institution computing system. The financial institution computing system may provide banking services to user devices (e.g., the sender device 106, the recipient device 108, etc.) by, for example, allowing users to use a client application (e.g., the client application circuit 146, the client application circuit 166, etc.) running on said user devices. Various functionality provided by the financial institution computing system via the client applications may include, but is not limited to, depositing funds into accounts, withdrawing funds from accounts, transferring funds between accounts, viewing account balances, requesting generation of one or more digital tokens, facilitating transfers of resources via the digital tokens including post-dated transfers, and the like. The provider computing system 102 includes, among other systems, a network interface circuit 112 enabling the provider computing system 102 to exchange data over network 110 and a processing circuit 114.

The network interface circuit 112 includes program logic that facilitates connection of the provider computing system 102 to the network 110. The network interface circuit 112 supports communication between the provider computing system 102 and other systems, such as the transaction machine 104, the sender device 106, and the recipient device 108. For example, the network interface circuit 112 may include a wireless fidelity (Wi-Fi) transmitter and receiver, a cellular modem, a Bluetooth transceiver, a Bluetooth beacon, a radio-frequency identification (RFID) transceiver, or a near-field communication (NFC) transmitter, among others. In some embodiments, the network interface circuit 112 communicates via a secure wired connection within a branch of a provider (e.g., a financial institution) associated with the provider computing system 102. In some arrangements, the network interface circuit 112 includes the hardware and machine-readable media sufficient to support communication over multiple channels of data communication. Further, in some arrangements, the network interface circuit 112 includes cryptography capabilities to establish a secure or relatively secure communication session with the provider computing system 102, the transaction machine 104, the sender device 106, and the recipient device 108. In this regard, financial data (or other types of data) may be encrypted and transmitted to prevent or substantially prevent the threat of hacking.

The processing circuit 114 includes a processor 116 and memory 118. The processor 116 may be implemented as one or more application specific integrated circuits (ASICs), field programmable gate arrays (FPGAs), a group of processing components, or other suitable electronic processing components. The memory 118 may be one or more devices (e.g., random access memory (RAM), read-only memory (ROM), flash memory or other solid-state memory, hard disk storage or other magnetic disk storage, etc.) for storing data and/or computer code for completing and/or facilitating the various processes described herein. The memory 118 may be or include non-transient volatile memory, non-volatile memory, and non-transitory computer storage media. The memory 118 may include database components, object code components, script components, or any other type of information structure for supporting the various activities and information structures described herein. The memory 118 may be communicably coupled to the processor 116 and include computer code or instructions for executing one or more processes described herein.

The provider computing system 102 includes a digital token circuit 120 that can receive requests for, generate, manage, verify, and process digital tokens to carry out transfers of resources, including post-dated transfers. The digital token circuit 120 may communicate with the transaction machine 104, the sender device 106, and the recipient device 108 via the network interface circuit 112. The digital token circuit 120 can receive a request from the sender device 106 to generate a digital token. The request may identify one or more of a resource that is to be transferred, an identifier of the recipient, an identifier of the recipient device 108, and a corresponding processing time value for the digital token. The processing time value may be a time value that corresponds to a date and time that the digital token may be processed using the techniques described herein, for example, to carry out a post-dated transfer of resource(s).

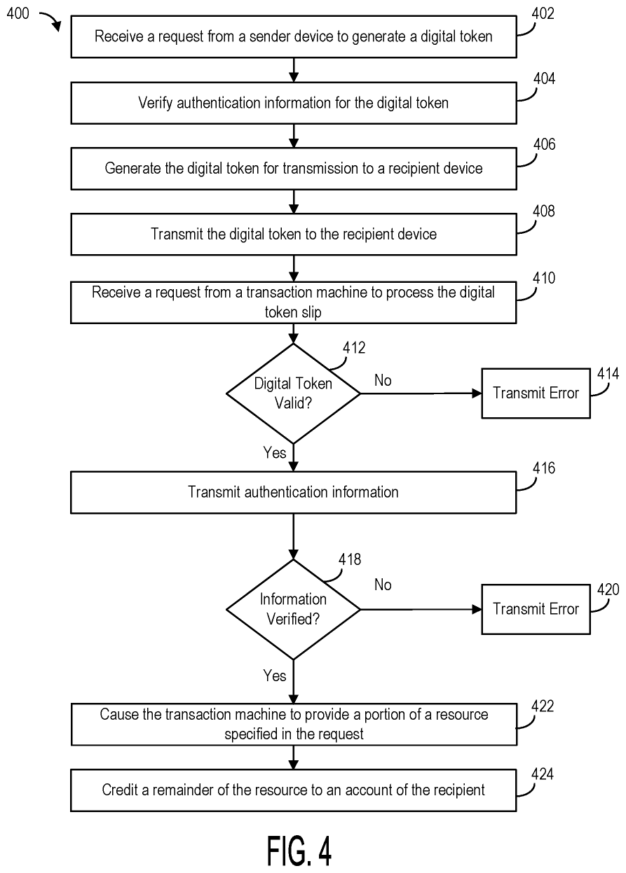

The digital token circuit 120 may perform any of the techniques described herein to generate and process digital tokens, including any of the operations described in connection with the method 400 of FIG. 4. As described herein, the digital token circuit 120 may perform various authentication processes to authenticate the sender, the sender device 106, the recipient, or the recipient device 108, to generate or process digital tokens. For example, the digital token circuit 120 may perform two-factor authentication, biometric authentication, contactless device authentication, among other types of authentication processes.

In some implementations, the digital token circuit 120 may perform two-factor authentication between the sender device 106 and the recipient device 108 to generate a digital token for a transfer of a resource. For example, upon receiving a request from the sender device 106 to generate a digital token for the transfer, the digital token circuit 120 can generate and transit authentication information (e.g., a PIN, a code, a barcode, a quick-response (QR) code, etc.) to the recipient device 108. The recipient device 108 can then display the authentication information to the sender, and the authentication information can be provided to the digital token circuit 120 via the sender device 106 to complete authentication for generating the digital token.

Similar authentication techniques may be performed by the digital token circuit 120 when processing the digital token to carry out the transfer via the transaction machine 105. For example, upon receiving a request from the transaction machine 104 to process a digital token provide to the recipient device 106 to complete the transfer of the resource, the digital token circuit 120 can generate and transit transfer authentication information (e.g., a PIN, a code, a barcode, a quick-response (QR) code, etc.) to the recipient device 108. The recipient device 108 can then display the authentication information to the recipient or otherwise provide the transfer authentication information to the transaction machine 104, and the transaction machine 104 can transmit the transfer authentication information to the digital token circuit 120 via the sender device 106 to complete authentication for processing the digital token.

The provider computing system 102 is also shown to include a digital token database 121. The digital token database 121 can retrievably store each digital token generated by digital token circuit 120. The digital token database 121 is shown as communicably and operatively coupled to the digital token circuit 120. The digital token database 121 can store mappings between digital tokens generated by the digital token circuit 120 and the transfer of the resource requested by via the sender device 106. To generate the digital token, the digital token circuit 120 can generate unique value, such as a unique fifteen-digit or fifteen-character alphanumeric code. In some implementations, the digital token can be generated or represented as a bar code, a QR code, or an encoded value that includes an arbitrary number of digits or characters. In some implementations, the digital token circuit 120 can generate a digital token based on the information included in the request to generate the digital token. For example, the digital token circuit 120 may execute an encoding algorithm using one or more of the identifier of the sender device 106, the identifier of the recipient device 108, or the processing time value of the digital token, to generate the digital token.

Upon generating a digital token in response to a request, the digital token circuit 120 can store the digital token in the digital token database 121 in association with any information included in or derived from the request (e.g., an identifier of the sender or sender device 106, an identifier of the recipient or recipient device 108, an identifier of the request, etc.). When a request to process a digital token is received (e.g., from the recipient device 108, from the transaction machine 104, etc.), the digital token circuit 120 can search the digital token database 121 to access and verify the digital token. The digital token database 121 can further store additional information relating to each digital token, such as an expiration time of the digital token, and a processing time value of the digital token (e.g., a time after which the digital token may be processed).

For example, upon receiving a request to process a digital token form the transaction machine 104 (e.g., an ATM, a point-of-sale (POS) system, etc.), the digital token circuit 120 searches for and accesses the information stored in association with the digital token identified in the request to perform one or more authentication procedures, as described herein. Using said information, the digital token circuit 120 can determine whether the identified digital token is valid. In some implementations, if the digital token circuit 120 receives a request to process a digital token that is not stored in the digital token database 121, the digital token circuit 120 can provide an error message to the computing device that transmitted the request.

A digital token may be considered invalid if it is expired or has been previously redeemed. In some implementations, if the digital token represents a post-dated transfer, the digital token circuit 120 can determine whether a current time falls after the processing time value stored in association with the digital token. If the processing time value has passed (e.g., the current time satisfies the requirements for the post-dated transfer), the digital token circuit 120 can carry out the transfer of resources as described herein. Otherwise, the digital token circuit 120 may generate an error message for display at the device that requested the digital token be processed.

Once a digital token has been processed, the digital token circuit 120 can access and update the digital token database 121 to store an indication that the digital token has been processed. The indication may include metadata such as an identifier of the device (e.g., the transaction machine 104, the recipient device 108) that requested the digital token be processed, a time at which the digital token was redeemed, an amount of the transferred resource that was provided directly to the recipient (e.g., via the dispenser 136 of the transaction machine 104, as described herein), or an amount of the transferred resource that was credited to an account of the recipient, among other information.

The environment 100 is shown as including include an transaction machine 104. The transaction machine 104 is a computing system that provides one or more interfaces between a user and the provider computing system 102, allowing the user to access information and perform transfers of resources (e.g., transactions, transfers of monetary funds, etc.) via the corresponding provider. In some implementations, the transaction machine 104 can include an ATM. In some implementations, the transaction machine 104 can include a POS, such as a POS of a retailer or of the provider. In some implementations, the transaction machine 104 can include a kiosk designated to process digital tokens.

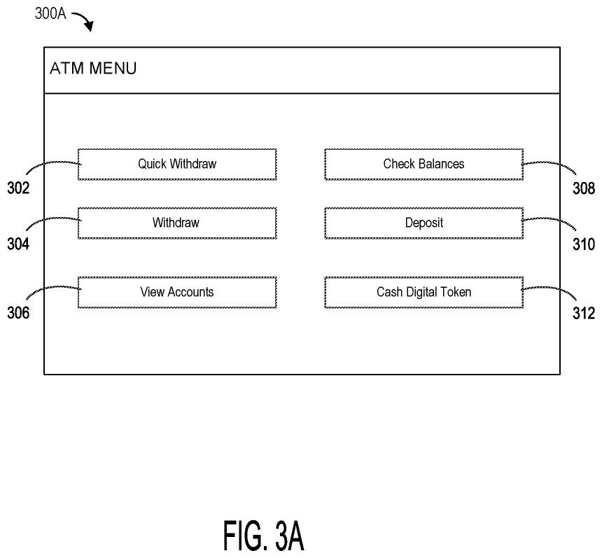

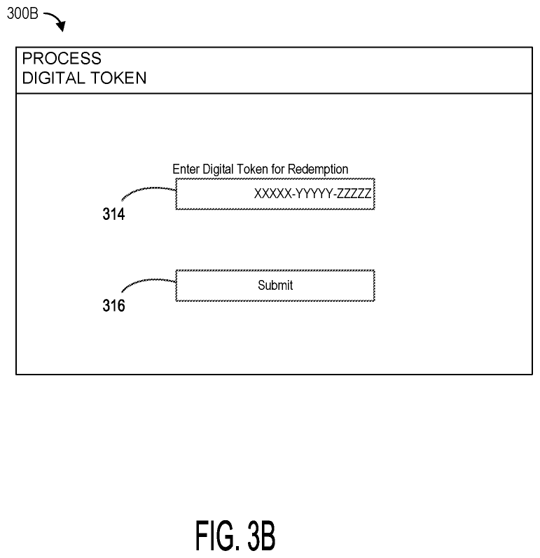

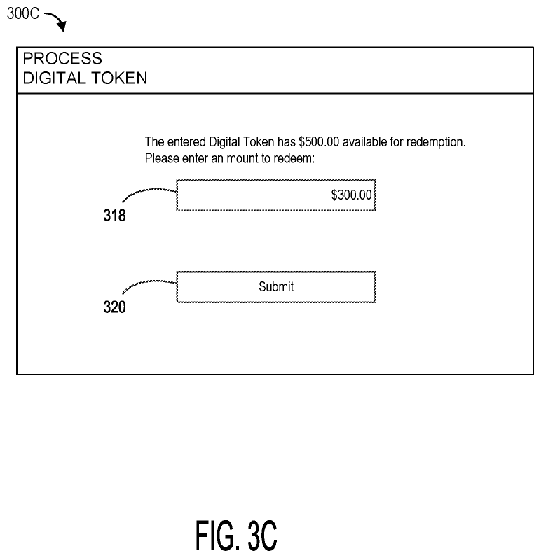

In some implementations, the transaction machine 104 can enable users to view account balances, deposit checks, transfer funds, or withdraw funds from a given account in the form of cash. To do so, the transaction machine 104 may present various graphical user interfaces, such as the graphical user interfaces described in connection with FIGS. 3A, 3B, and 3C. The transaction machine 104 may provide an interface between a user and the provider computing system 102 to process (e.g., redeem) digital tokens, including digital tokens that represent a post-dated transfer of a resource. For example, the transaction machine 104 can transmit requests to the provider system 102 to process a digital token provided to the transaction machine 104. The transaction machine 104 may receive the digital token via user input, via an input device such as a camera (e.g., to scan a barcode or QR code), via a designated barcode scanner, or via contactless transfer from the recipient device 108 (e.g., NFC communication, Bluetooth communication, etc.).

As shown, and for the purpose of clarity, the disclosure contained herein is in reference to a single transaction machine 104. This depiction is for illustrative purposes only to show an implementation environment of the systems and methods described herein. The provider computing system 102 may be communicably and operatively coupled with multiple transaction machines that may have the same or similar characteristics as illustrated with the example embodiment of transaction machine 104.

The transaction machine 104 is shown to include a network interface circuit 122 that facilitates connection of the transaction machine 104 to the network 110. The network interface circuit 122 of the transaction machine 104 is adapted for and configured to establish a communication session via the network 110 between the transaction machine 104 and other systems, such as the provider computing system 102, the sender device 106, and the receiver device 108. Accordingly, the network interface circuit 122 includes any of a cellular transceiver (Code Division Multiple Access (CDMA), Global System for Mobile Communications (GSM), Long-Term Evolution (LTE)), a wireless network transceiver (e.g., 802.11X, ZigBee, Bluetooth), or a combination thereof (e.g., both a cellular transceiver and a Bluetooth transceiver). In some embodiments, the network interface circuit 122 communicates via a secured wired connection within a branch of the provider associated with the provider computing system 102. The network interface circuit 122 may be the same or similar as the network interface circuit 112 previously described with reference to the provider computing system 102.

The transaction machine 104 is shown include a processing circuit 124 including a processor 126 and memory 128. The processing circuit 124, processor 126, and memory 128 may be the same or similar as the processing circuit 114, processor 116, and memory 118 described respectively with reference to the provider computing system 102. The transaction machine 104 is shown to include an input/output (I/O) circuit 130 that can receive and provide communications to an operator of the transaction machine 104. The I/O circuit 130 can exchange data, communications, instructions, etc. with the recipient device 108 and/or a user associated with the recipient device 108. For example, the recipient device 108 may transmit authentication information to the transaction machine 104 to complete an authentication process initiated by the provider computing system 102.

In some implementations, the I/O circuit 130 includes an input/output device such as a display device, a touchscreen, a keyboard, a microphone, a barcode scanner, or a QR scanner. In various arrangements, the I/O circuit 130 includes communication circuitry for facilitating the exchange of data, values, messages, and the like between an input/out device and the components of the transaction machine 104. In some embodiments, the I/O circuit 130 includes machine-readable media for facilitating the exchange of information between the input/out device and the components of the transaction machine 104. The I/O circuit 130 may include any combination of hardware components (e.g., a touchscreen), communication circuitry, and machine-readable media. In some implementations, the I/O circuit 130 includes hardware that facilitates input of a digital token. For example, the I/O circuit 130 may include a touchscreen, keyboard, keypad, or other physical input device that receives user input to provide the digital token. In another example, the I/O circuit 130 may include contactless sensors that detect or receive the digital token, such as barcode scanners, QR code scanners, NFC transceivers, wireless communication circuits, or the like. Once received, the I/O circuit 130 may communicate the digital token to digital token circuit 120 of the provider computing system 102 in a request to process the digital token. Transmitting the request to process the digital token can cause the digital token circuit to authenticate request to process the digital token, which may include performing one or more authentication procedures via the recipient device and/or the transaction machine 104.

The transaction machine is shown as including an authentication circuit 132. In one example implementation, upon receiving the request to process the digital token from the transaction machine 104, the digital token circuit 120 can identify the identifier of the recipient device 108 corresponding to the digital token from the digital token database 121 and transmit two-factor authentication information (e.g., a code generated by the token circuit 120) to the recipient device 108. The recipient can then provide the two-factor authentication information manually to the authentication circuit 132 via the I/O circuit 130 of the transaction machine 104, or wirelessly via contactless methods described herein. The authentication circuit 132 can then transmit the received authentication information to the digital token circuit 120 to complete the two-factor authentication process.

The authentication circuit 132 may gather additional or alternative authentication data for additional or alternative authentication processes to authenticate the recipient when receiving a digital token for processing. Such authentication information may include, but is not limited to, a biometric data, a facial recognition process, PIN input, or a username and password combination, among others. The biometric data may include a fingerprint scan, a retinal scan, or an iris scan, among others. The authentication circuit 132 may include one or more components, devices, and corresponding hardware to capture or otherwise receive the authentication information for the recipient. Such hardware may include cameras, retinal scanners, or fingerprint scanners, among others.

The types of authentication information required may be indicated in a communication from the digital token circuit 120, and may be a function of the type or quantity of the transfer for which the digital token was generated. For example, for digital tokens that represent monetary transfers that exceed predefined thresholds, additional authentication procedures such as biometric scans may be utilized. Once the authentication information is captured via the authentication circuit 132, the authentication circuit 132 can transmit the authentication information to the digital token circuit 120. The digital token circuit 120 can then compared the received authentication information to expected authentication information for the recipient (e.g., a known username and password, previously received biometric information, etc.) to authenticate the recipient. If the recipient is authenticated, the digital token circuit 120 can transmit a message to the authentication circuit 132 indicating that the recipient is authenticated. Otherwise, the digital token circuit 120 may transmit an error message indicating authentication has failed.

The transaction machine 104 includes a display 134 used to present account information, transaction information, and the like to users on the transaction machine 104. The display 134 is communicably and operatively coupled to the I/O circuit 130 to provide a user interface for receiving and displaying information on the transaction machine 104. Examples of user interfaces include digital screens, lights, or voice instructions, among others. Example graphical user interfaces that may be displayed via the display 134 are shown in FIGS. 3A, 3B, and 3C. The display 134 provides instructions (e.g., determined by the I/O circuit 130, determined by the authentication circuit 132) to the user for facilitating processing of a digital token. For example, the display 134 presents an instruction to a user requesting that the user inputs a digital token, authentication information (e.g., a two-factor code, etc.), or a request to perform a biometric scan for authentication. The display 134 is configured to display information relating to the digital token entered by a user, including any associated expiration times, processing time values, or resource amounts (e.g., a monetary amount), among others.

The transaction machine 104 includes a dispenser 136 structured to dispense a predetermined amount of cash to a user of the transaction machine 104. The dispenser 136 is communicatively and operatively coupled to the I/O circuit 130 and/or the authentication circuit 132 to dispense an amount of resources associated with a digital token. The dispenser 136 may be, for example, a cash dispenser that may dispense an amount of cash requested by the user. In some implementations, the cash dispenser 136 may only be configured to dispense a predetermined amount of cash (e.g., a limit). If the user requests that more than the limit be dispensed, the dispenser 136 may dispense a cash amount up to the limit, and transmit a signal (e.g., via the network interface circuit 122) to the digital token circuit 120, causing the digital token circuit 120 to credit an account of the recipient by the remainder of the amount of resources represented by the digital token (e.g., the amount that was not dispensed by the dispenser 136). In various arrangements, the dispenser 136 is communicatively and operatively coupled to the provider computing system 102 allowing a user to perform generic ATM transaction processes (e.g., deposit a cash/check into an account, withdraw funds from an account, etc.).

The environment 100 is shown to include a sender device 106 which is a computing device associated with a sender (e.g., a transferor). In some arrangements, the user is an account holder of at least one account managed by the provider (associated with provider computing system 102). An example account includes a checking account, a savings account, a credit account, an investment account, a retirement account, a brokerage account, a mortgage account, a rewards account, and the like. Such accounts include information indicating account balances, account activities, profile information (e.g., contact information of user), ATM transaction history, among others.

The sender device 106 includes any type of computing device that is used to conduct financial transactions and/or receive information from the provider computing system 102, the transaction machine 104, and/or the recipient device 108. In some arrangements, the sender can use the sender device 106 to both communicate information to the provider computing system 102 over the network 110 as well as communicate information with the recipient device 108. In some implementations, the sender device 106 may include any type of mobile device including, but not limited to, a phone (e.g., smart phone), tablet, personal digital assistant, key fob, card/badge, and/or computing devices (e.g., desktop computer, laptop computer, personal digital assistant).

In the example embodiment of FIG. 1, the sender device 106 includes a network interface circuit 138 enabling the sender device 106 to exchange information over the network 110, a processing circuit 140, and an input device 150. The processing circuit 140 is shown to include a processor 142 and memory 144 including a client application circuit 146. The processing circuit 140, processor 142, and memory 144 may be the same or similar as the processing circuit 114, processor 116, and memory 118 respectively described with reference to the provider computing system 102.

The network interface circuit 138 of the sender device 106 is adapted for and configured to establish a communication session via the network 110 between the sender device 106 and other systems, such as the provider computing system 102, ATM 104, and the recipient device 108 computing system 108. Accordingly, the network interface circuit 138 includes any of a cellular transceiver (e.g., CDMA, GSM, LTE, etc.), a wireless network transceiver (e.g., 802.11X, ZigBee, Bluetooth), or a combination thereof (e.g., both a cellular transceiver and a Bluetooth transceiver). In some embodiments, the network interface circuit 138 communicates via a secured wired connection within a branch of the provider associated with the provider computing system 102. The network interface circuit 138 may be the same or similar as the network interface circuit 112 previously described with reference to the provider computing system 102.

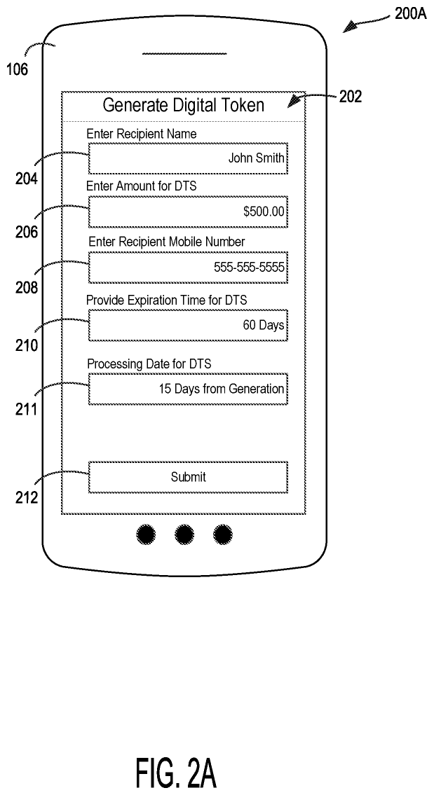

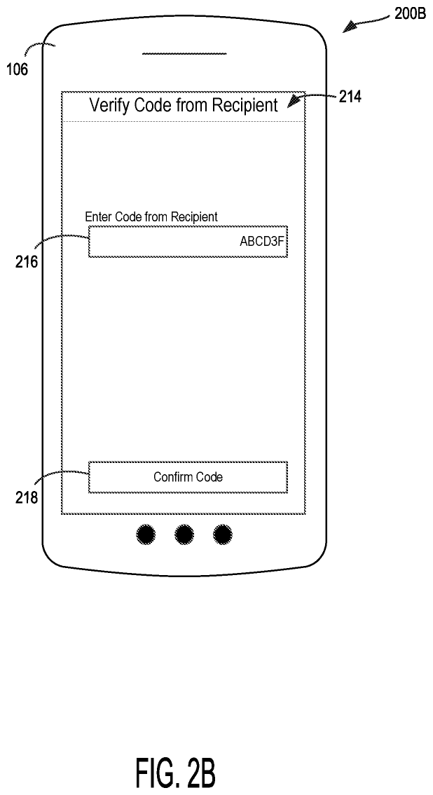

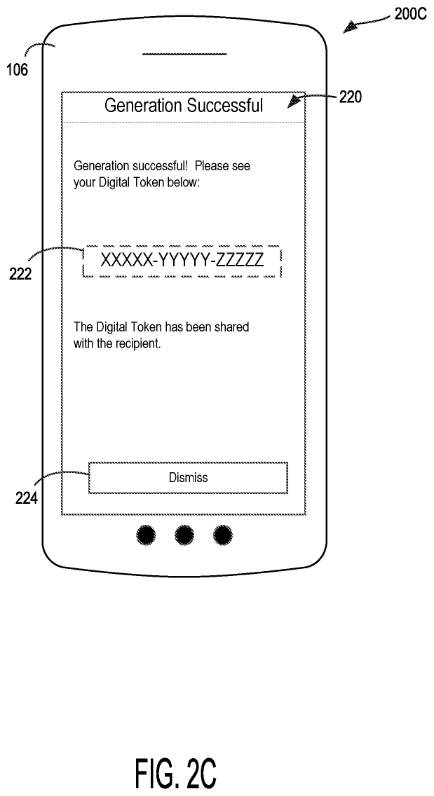

The client application circuit 146 is structured to present graphical user interfaces via a display of sender device 106 that enable the sender to initiate requests to generate digital tokens. Examples of such graphical user interfaces are shown in FIGS. 2A, 2B, and 2C. The client application circuit 146 is communicably and operatively coupled to the provider computing system 102 via the network 110. The client application circuit 146 may be incorporated with an existing application in use by the provider (e.g., a mobile banking application or a mobile wallet application). In other embodiments, the client application circuit 146 may be downloaded by the sender device 106 prior to its usage, hard-coded into the memory 144 of the sender device 106, or be a web-based interface application, which may be executed remotely from the sender device 106. In the latter instance, the user may have to log onto or access the web-based interface before usage of the application. In such implementations, the client application circuit 146 may be supported by a separate computing system including one or more servers, processors, network interface circuits, etc. that transmit applications for use to the sender device 106. In some implementations, the client application circuit 146 includes and may invoke an application programming interface (API) that facilitates the integration of other applications with the client application circuit 146.

The client application circuit 146 can present one or more graphical user interfaces that enable a sender to request generation of a digital token that represents a transfer of a resource. The transfer may a post-dated transfer (e.g., a transfer that can be processed after a predetermined amount of time has elapsed). Examples of such graphical user interfaces are described in connection with FIGS. 2A, 2B, and 2C. As described in further detail herein, the graphical user interfaces may include interactive elements that enable the sender to designate a sender and provide various attributes of the transfer. For example, the sender may use the graphical user interfaces to specify one or more accounts of the sender from which the transfer should be performed, the recipient of the transfer, and an amount of resources to transfer to the recipient, among other attributes. Once the information for the transfer has been provided, the client application circuit 146 can transmit a request to generate the digital token to the digital token circuit 120, as described herein.

The sender device 106 is shown as including an input device 150, which may include a touchscreen, keyboard, or other another type of device that is capable of receiving user input. In some implementations, the input device 150 can include biometric input devices, such as cameras, fingerprint scanners, or retinal scanners, among others. The input device 150 may capture authentication information of the sender to transmit to the provider computing system 102 for authentication (e.g., in response to a request from the provider computing system 102). The provider computing system 102 may transmit a request to authenticate the sender upon receiving a request to generate a digital token. The input device 150 may be operated by the sender to provide input to populate the graphical user interfaces described herein to request generation of a digital token. The input device 150 may include any of the structure of, and implement any of the functionality of, the I/O circuit 150.

The environment 100 is shown to include a recipient device 108 which is a computing device associated with a sender (e.g., a transferor). In some arrangements, the user is an account holder of at least one account managed by the provider (associated with provider computing system 102). An example account includes a checking account, a savings account, a credit account, an investment account, a retirement account, a brokerage account, a mortgage account, a rewards account, and the like. Such accounts include information indicating account balances, account activities, profile information (e.g., contact information of user), ATM transaction history, among others.

The recipient device 108 includes any type of computing device that is used to conduct financial transactions and/or receive information from the provider computing system 102, the transaction machine 104, and/or the sender device 106. In some arrangements, the sender can use the recipient device 108 to both communicate information to the provider computing system 102 over the network 110 as well as communicate information with the transaction machine 104 or the sender device 106. In some implementations, the recipient device 108 may include any type of mobile device including, but not limited to, a phone (e.g., smart phone), tablet, personal digital assistant, key fob, card/badge, and/or computing devices (e.g., desktop computer, laptop computer, personal digital assistant).

The recipient device 108 is shown to include a network interface circuit 152 enabling the recipient device 108 to exchange information over the network 110, a processing circuit 154, and an input device 160. The processing circuit 154 is shown to include a processor 156 and memory 158 including a client application circuit 166. The processing circuit 154, the input device 160, the processor 156, and the memory 158 may be the same or similar as the processing circuit 140, the input device 150, the processor 142, and the memory 144 described respectively with reference to the sender device 106. The recipient device 108 may be similar to, and implement any of structure or functionality of, the sender device 106, and vice versa.

The recipient device 108 is shown to include a client application circuit 166 communicably coupled to the provider computing system 102, the transaction machine 104, and/or the sender device 106 via the network 110. In certain embodiments, the client application circuit 166 includes and may invoke one or more APIs that facilitate the integration of other applications with the client application circuit 166. In various arrangements, the client application circuit 166 may receive notifications or messages from the provider computing system 102 to perform verification for generating and/or processing digital tokens. In one example, the digital token circuit 120, upon receiving a request to generate a digital token identifying the recipient device 108, may transmit a request for authentication to the recipient device. The request may be a request for biometric data, which the digital token circuit 120 may utilize as described herein to biometrically authenticate the recipient. The biometric data may be provided via the input device 160.

In another example, the digital token circuit 120 may coordinate a two-factor authentication process between the recipient device 108 and the sender device 108. To do so, the digital token circuit 120 may generate two-factor authentication information (e.g., an alphanumeric code, a barcode, a QR code, etc.) that may be provided to the client application circuit 166. Upon receipt, the client application circuit 166 can display the authentication information to the recipient, who can then provide (e.g., transmit, communicate, etc.) the authentication information to the sender device 106 (e.g., via a message, via manual entry, via contactless or wireless transmission, etc.).

The client application circuit 146, upon receiving the authentication information from the client application circuit 166, may transmit a message including the authentication information to the digital token circuit 120, completing the authentication process. The digital token circuit 120 can compare the authentication information received from the sender device 106 to the authentication information transmitted to the recipient device 108. If the values match, the digital token circuit 120 can determine that the sender device 106 and the recipient device 108 are authenticated, and proceed to generate the digital token representing the digital transfer of a resource as described herein.

The client application circuit 166 may also perform similar two-factor authentication approaches when a request is made to process a digital token. In one example, the recipient may provide a generated digital token to the transaction machine 104 (e.g., via manual entry, wireless transmission, contactless information transfer, etc.), which can generate and transmit a request to process the digital token to the digital token circuit 120. In response to receiving the request, the digital token circuit may transmit a request for authentication information to the recipient device 108 (which may be identified in the digital token database 121 as associated with the digital token) or to the transaction machine 104. The request for authentication information may be a request for biometric data, a request for two-factor authentication information, or a request for authentication credentials, among others.

In the example where the digital token circuit 120 requests biometric information, the request may be transmitted to the transaction machine 104 or the recipient device 108, and displayed to the recipient via a respective display. The recipient may then provide the requested biometric information via the authentication circuit 132 (if the request was transmitted to the transaction machine 104) or via the input device 160 (if the request was transmitted to the recipient device 108). The captured biometric data can then be transmitted to the digital token circuit 120 to complete the request for authentication.

In an example where the digital token circuit 120 requests a two-factor authentication information, the digital token circuit 120 can generate two-factor authentication information (e.g., an alphanumeric code, a barcode, a QR code, etc.) that may be provided to the client application circuit 166. Upon receipt, the client application circuit 166 can display the authentication information to the recipient, who can then provide (e.g., transmit, communicate, etc.) the authentication information to the transaction machine 104 (e.g., via a message, via manual entry, via contactless or wireless transmission, etc.).

The transaction machine 104, upon receiving the authentication information from the client application circuit 166, may transmit a message including the authentication information to the digital token circuit 120, completing the authentication process. The digital token circuit 120 can compare the authentication information received from the transaction machine 104 to the authentication information transmitted to the recipient device 108. If the values match, the digital token circuit 120 can determine that the sender device 106 and the recipient device 108 are authenticated and proceed to generate the digital token representing the digital transfer of a resource as described herein. In another implementation, the recipient may utilize another mobile device (e.g., a tablet device) executing an application similar to the client application circuit 166 to request processing of the digital token, and can perform similar two-factor authentication or biometric authentication approaches to authenticate the recipient.

In some implementations, the recipient may request processing of a digital token via the client application circuit 166. In such implementations, the client application circuit 166 may transmit the request to process a digital token (previously provided to the recipient) to the digital token circuit 120. In response, the digital token circuit 120 may transmit a request for authentication information to the recipient device 108. The request may include a request for authentication credentials (e.g. username, password, e-mail, alphanumeric PIN), biometric information, or two-factor authentication information. The recipient can provide the requested information (e.g., via the input device 160), which can be transmitted to the digital token 120. The digital token circuit 120 may then process the digital token if authentication is successful, as described herein, or transmit an error message for display via the client application circuit 166 if unsuccessful.

Any of the various prompts, requests, or information described as provided to any of the sender device 106, the recipient device 108, or the transaction machine 104 may be presented in one or more graphical user interfaces, notifications, prompts, pop-up messages, overlays, frames, pages, or other graphical user interface elements. Example graphical user interfaces that may be presented via the client application circuit 146 of the sender device 106 when requesting generation of a digital token for a transfer of a resource are shown in FIGS. 2A, 2B, and 2C. Example graphical user interfaces that may be presented via the display 134 of the transaction machine, or similarly by the client application 160, when requesting processing of a digital token to complete the corresponding transfer of the resource are shown in FIGS. 3A, 3B, and 3C.

Referring to FIGS. 2A, 2B, and 2C, illustrated are diagrams showing example graphical user interfaces 200A, 200B, and 200C for requesting a digital token, in accordance with one or more implementations. Referring to FIG. 2A with reference to the components described in FIG. 1, illustrated is an example graphical user interface 200A that may be displayed via the client application circuit 146 of the sender device 106. The graphical user interface 200A may be displayed in response to interacting with an interactive graphical element presented via the client application circuit 146 to request generation of a digital token to represent a transfer of a resource (e.g., a monetary amount). In the example graphical user interface, the heading 202 indicates that the current interface is presented to request generation of a digital token for a transfer of a resource, such as a monetary amount, information, or another type of physical or digital asset.

As shown, the graphical user interface 200A includes a first field 204 (sometimes referred to as the “first interactive element 204” or “interactive element 204”) that can receive an identifier of the recipient of the transfer that will be represented by the digital token. In this example, the identifier is a name of the recipient, however, it should be understood that any suitable identifier may be utilized (e.g., username, email address, alphanumeric PIN, etc.) to identify the recipient. Although the interactive element 204 is shown as text-entry box, it should be understood that the interactive element 204 may be any type of graphical user interface element via which the recipient may be identified, and may include but is not limited to drop down menus with scroll bars, a contact selection interface (e.g., to select the recipient as identified in a contacts list stored at the sender device 106), or any other type of interactive element.

In this example, the graphical user interface 200A further includes a second field 206 (sometimes referred to as the “second interactive element 206” or “interactive element 206”) that can receive an amount of a resource that the digital token will represent. As shown, the resource in this example is a monetary amount that equals $500.00. Any monetary amount may be represented or provide via the second interactive element 206. In implementations where the resource is a non-monetary value, such as rewards points, information, or a digital or physical asset, interactive element 206 may include interactive features that enable selection or provision of an identifier of the resource that the digital token is to represent.

Furthering this example, the graphical user interface 200A is shown as including a third field 208 (sometimes referred to as the “third interactive element 208” or “interactive element 208”) that can receive an identifier of the recipient device 108. In this example, the identifier is a mobile phone number, however, any suitable identifier may be utilized (e.g., username, email address, alphanumeric PIN, etc.) to identify the recipient device 108. In some implementations, the identifier of the recipient is sufficient to identify the recipient device 108, and therefore the identifier of the recipient device 108 need not necessarily be entered, and the interactive element 208 need not necessarily be displayed.

The graphical user interface 200A may include a fourth field 210 (sometimes referred to as the “fourth interactive element 210” or “interactive element 210”) that enables the sender to specify an expiration time for the digital token (e.g., an amount of time from the generation of the digital token that the token is valid). The interactive element 210 may include any type of user interface element that enables selection of a date (e.g., an overlay calendar interface) or a period of time that the digital token is to be valid (e.g., a slider, radio bubbles, etc.). In some implementations, if no expiration date is applied, the digital token circuit 120 may automatically generate a default expiration timeframe for the digital token (e.g., 90 days from generation, etc.).

The sender may also provide a date or time after which the digital token may be processed (e.g., for a post-dated transfer) in the fifth field 211 (sometimes referred to as the “fifth interactive element 211” or “interactive element 211”). Although shown here as a text-entry field, the interactive element 211 may include any type of user interface element that enables selection of a date (e.g., an overlay calendar interface) or a period of time after which the digital token may be processed (e.g., a slider, radio bubbles, etc.). In some implementations, if no expiration date is applied, the digital token circuit 120 may automatically generate a default processing time value for the digital token (e.g., valid immediately from generation, etc.).

In some implementations, the graphical user interface 200A may, in the case of a monetary transfer, include an interactive element to enable a selection of an account of the sender from which the monetary amount is to be transferred. For example, the graphical user interface 200A may provide a drop-down menu, or a list of selectable accounts, via which the sender may select the account from which the amount provided in the interactive element 206 is to be transferred. In some implementations, the accounts may be non-financial accounts, such as loyalty or rewards points accounts. The account selected to

The graphical user interface 200A includes the submit button 212, which when interacted with, causes the client application circuit 146 to generate and transmit a request to generate digital token representing the transfer of the resource (e.g., the resource indicated in the interactive element 206). The request may include any of the information provided by the sender via the graphical user interface 200A. The submit button 212 may be any type of interactive element, and is not limited to a button. For example, the submit button 212 may be a hyperlink, a graphic, a slider, or any other type of graphical user interface element. Upon an interaction with the submit button, the client application circuit 146 may transition the display of the graphical user interface 200A of FIG. 2A to display the graphical user interface 200B of FIG. 2B.

Referring to FIG. 2B in the context of the components of FIG. 1, illustrated is an example graphical user interface 200B presented during an authentication process for generating the digital token. The graphical user interface 200B is shown as including the header 214, indicating an authentication process for generating the requested digital token. As described herein, the digital token circuit 120 can generate requests for authentication prior to generating a requested digital token. In this example, the authentication process provided via the digital token circuit includes a two-factor authentication process between the sender device 106 and the recipient device 108. In this example, the digital token circuit 120 has generated and transmitted authentication information to the recipient device 108, such that the authentication information is accessible to the recipient.

The recipient has then provided the authentication information to the sender (e.g., via an electronic transmission to the sender device 106, via manual, in-person communication, via contactless device communication, etc.). Once received by the sender device 106, the authentication information may be provided as input to the interactive element 216 (shown here as a text-entry field). In this example, the authentication information is represented as an alphanumeric code. However, the authentication information for two-factor processes may take any digital information. In one example, the graphical user interface 200B may display a camera interface to capture a barcode or QR code displayed via the recipient device 108.

In another example, the graphical user interface 200B may display a prompt to the sender to position the sender device 106 close to the recipient device 108 to facilitate contactless transfer of the authentication information. Similar prompts or graphical user interfaces may be provided via the client application circuit 166 of the recipient device 108. Once the authentication information has been provided to the client application circuit 146, a confirmation button 218 may be displayed in the graphical user interface 200B. Upon detecting an interaction with the confirmation button 218, the client application circuit 146 can transmit the authentication information to the digital token circuit 120 to complete the authentication process, as described herein. Upon completion of the authentication process (which may include additional authentication procedures, such as biometric authentication of the sender and/or recipient), the digital token circuit 120 can generate the digital token representing the transfer of the resource, and transmit the digital token to the sender device 106 for display. Upon receiving the digital token, the client application circuit 146 can transition to the graphical user interface 200C of FIG. 2C.

Referring to FIG. 2C in the context of the components of FIG. 1, illustrated is an example graphical user interface 200C presented following generation and receipt of a requested digital token. The graphical user interface 200C is shown as including the header 220, indicating successful generation of the requested digital token. As described herein, the digital token circuit 120 can generate and provide the digital token to the sender device 106 and/or the recipient device 108. In this example, digital token is represented as the alphanumeric text string 222, which in this example is fifteen characters long (with dashes included to improve readability). The graphical user interface 200C includes an indication that the digital token was generated successfully. If the digital token was transmitted to the recipient device 106 (as in this example), the graphical user interface 200C can include an indication that the digital token has transmitted to the recipient device 106, as shown.

In some implementations, the graphical user interface 200C may include one or more interactive elements that cause the client application circuit 146 to transmit the digital token to the recipient device 108. The digital token may be transmitted via wireless communication (e.g., contactless information transfer, Bluetooth, Wi-Fi, NFC, etc.), or via one or more electronic messages (e.g., a social media message, a short-message-system (SMS) message, etc.). Although shown here as an alphanumeric code, the digital token may be presented in the graphical user interface 200C as a barcode, a QR code, or another type of code that may be captured by a scanner or camera of the recipient device 108. In such implementations, the client application circuit 166 of the recipient device 160 may initiate a scan or capture of the digital token displayed in the graphical user interface 200C at the sender device 106 to complete the transfer of the digital token. Once provided to the recipient device 108, the recipient may process the digital token to complete the transfer of the resource via the transaction machine 104 (e.g., an ATM, a POS, a kiosk, etc.) or via the recipient device 108.

Referring to FIGS. 3A, 3B, and 3C, illustrated are diagrams showing example graphical user interfaces 300A, 300B, and 300C for processing a digital token, in accordance with one or more implementations. Referring to FIG. 3A in the context of the components described in connection with FIG. 1, illustrated is an example graphical user interface 300A that may be presented via a transaction machine 104. In this example, the transaction machine 104 may be an ATM, and the graphical user interface 300A may be presented as a screen to the user following entry of a PIN or another authentication process at the transaction machine. As shown, the graphical user interface 300A includes the interactive elements 302, 304, 306, 308, 310, and 312. The interactive elements 302, 304, 306, 308, 310 each correspond to a quick withdrawal functionality, withdrawal functional, an option to view accounts, an option to check balance(s) of one or more accounts, and an option to deposit cash or checks into one or more accounts, respectively. Other ATM functionalities may also be presented via the graphical user interface 300A.

The graphical user interface 300A further includes an additional interactive element 312, corresponding to an option to process a digital token. Selection of the interactive element 312 may cause presentation of the graphical user interface 300A to transition to the graphical interface 300B of FIG. 3B. In this example, once a digital token has been generated and provided to the recipient, the recipient can access the transaction machine 104 to process the digital token to complete the transfer of the resource represented by the digital token. In some implementations, prior to transitioning to the graphical interface 300B of FIG. 3B, the transaction machine 104 may present one or more graphical user interfaces that request authentication information from the recipient, such as authentication credentials (e.g., username, password, email address, a second PIN corresponding to digital token processing requests, etc.), biometric information, or any other authentication information presented herein. Furthering this example, upon authenticating the recipient (e.g., via the provider computing system 102), the transaction machine 104 can transition to the graphical interface 300B of FIG. 3B.

Referring to FIG. 3B in the context of the components described in connection with FIG. 1, illustrated is an example graphical user interface 300B that may be presented once the recipient has requested processing of a digital token. As shown, the graphical user interface 300B includes an interactive field 314, in which the recipient may provide the digital token for processing. In this example, the digital token is a fifteen character alphanumeric code. In some implementations, the digital token may be represented by a bar code or QR that may be presented via the recipient device 108, and captured by an input device (e.g., the I/O circuit 130) of the transaction machine 104. In such implementations, the graphical user interface 300B may prompt the recipient to capture an image or scan of the digital token. In some implementations, the digital token may be provided via contactless transmission (e.g., NFC signal, Bluetooth, etc.) to the transaction machine 104. In such implementations, the graphical user interface 300B may prompt the recipient to perform contactless information transfer to the transaction machine 104 via the recipient device 108.

Once the digital token has been provided to the transaction machine 104, the recipient can interact with the submit button 316 to proceed to cause the transaction machine 104 to transition to the graphical user interface 300C of FIG. 3C to continue redemption of the digital token. In some implementations, prior to transitioning to the graphical user interface 300C of FIG. 3C, the transaction machine 104 can transmit the entered digital token to the digital token circuit 120 of the provider computing system 102. The digital token circuit 120 can verify that the entered digital token is exists in the digital token database 121, that the entered digital token has not already been redeemed, that the entered digital token has not expired, and that a current time has passed the processing time value of the digital token (e.g., the current time satisfies the date of the post-dated transfer). If any of these are not satisfied, the digital token circuit 120 can transmit an error message that indicates the digital token does not exist, that the entered digital token has already been redeemed, that the digital token has expired, or that the digital token cannot yet be processed, respectively.

If the digital token is valid (e.g., exists in the database, has not already been redeemed, has not expired, and the current time satisfies the processing time value of the digital token), the digital token circuit 120 can generate and transmit a request for authentication information to the recipient device 108, as described herein in connection with FIG. 1. In a two-factor authentication example, the digital token circuit 120 can transmit authentication information (e.g., a six-digit alphanumeric code, etc.) to the recipient device 108 identified in the digital token database 121, which can display the authentication information to the recipient. The recipient can then enter the authentication information into a corresponding graphical user interface displayed at the transaction machine 104, which can then transmit the entered authentication information to the digital token circuit 120, as described herein, to authenticate the recipient. In some implementations, once the recipient has been authenticated, the transaction machine 104 can display the graphical user interface 300C of FIG. 3C.

Referring to FIG. 3C, illustrated is an example graphical user interface 300C that enables the recipient to redeem a portion of the resource represented by the digital token entered in the graphical user interface 300A. In this example, the resource is a monetary amount, and the graphical user interface 300C includes an interactive element 318 that receives a monetary value up to the amount represented by the digital token. As shown, the graphical user interface 300C includes an indication of the total amount of the resource represented by the digital token (e.g., $500). Once the recipient has entered in the portion of the digital token to redeem, the recipient can interact with the submit button 320. In some implementations, the graphical user interface 300C can include a button that enables the recipient to redeem all of the resource associated with the digital token.

Upon an interaction to redeem the digital token, the transaction system 104 can transmit dispense (e.g., via the dispenser 136) a monetary equal to the amount entered into the interactive field 318. If the user requests that more than a predetermined monetary limit be dispensed via the transaction machine 104, the transaction machine 104 can dispense a monetary amount up to the limit. The remaining amount not dispensed can be transmitted to the digital token circuit 120, causing the digital token circuit 120 to credit an account of the recipient by the remainder of the amount of resources represented by the digital token (e.g., the amount that was not dispensed by the transaction machine 104). Once the transaction machine 104 has redeemed the digital token, the transaction machine 104 can transmit a signal to the digital transaction circuit 120, which can store an indication that the digital token is redeemed. In some implementations, the transaction machine 104 may then display a graphical user interface that indicates the digital token has been redeemed, and may transition the display (e.g., in response to an interaction, after a predetermined time period) to the graphical interface 300A of FIG. 3A.

Although the graphical user interfaces 300A, 300B, and 300C have been described in the context of the transaction machine 104, it should be understood that in some implementations, a digital token may be processed via the recipient device or any other type of computing device. In such implementations, the client application circuit 166 can display one or more graphical interfaces similar to those described in connection with FIGS. 3A, 3B, and 3C. For example, the client application circuit 166 may present interactive elements that enable the recipient to enter a digital token and perform authentication processes requested by the digital token circuit 120. Because the recipient device 108 may not necessarily include a dispenser such as the dispenser 136, upon authenticating the recipient, the digital token circuit 120 may instead credit the resource associated with the digital token to an account of the recipient. The account may be selected via the client application circuit 166, in some implementations.

Referring to FIG. 4, illustrated is a flowchart of an example method 400 of requesting, generating, and processing digital tokens, in accordance with one or more implementations. In various embodiments, the method 200 is performed by the components of environment 100 described in connection with FIG. 1, such that reference may be made to components of FIG. 1 to aid the description of method 400. Through the method 400, the provider computing system 102 receives a request to generate a digital token for a transfer of a resource, performs various authentication techniques to authenticate the sender and/or recipient of the resource, generates the digital token, and processes the digital token in response to a corresponding request from a recipient. The provider computing system stores, maintains, and updates the generated digital tokens the digital token database 121.

The method 200 can be implemented in a variety of example use cases. A first example user case situation includes performing method 400 to generate, in response to a request from a sender, a digital token representing a post-dated transfer of a resource, which is then provided to a recipient. The recipient then processes the digital token to complete the transfer of the resource at a transaction machine 104 (e.g., an ATM). The transaction machine 104 may dispense a portion of, or all of, the resource. A portion may be dispensed if requested by the recipient, or if the transaction machine 104 cannot dispense an amount of the resource that exceeds a predetermined limit (e.g., a withdrawal limit). The remainder of the resource not dispensed by the transaction machine 104 can be transferred to an account (e.g., a default account, a selected account, etc.) of the recipient. In another example use case, the method 400 may be performed to generate, in response to a request from a sender, a digital token representing a post-dated transfer of a resource, which is then provided to a recipient. The recipient then processes the digital token via their recipient device 108 to complete the transfer of the resource to an account (e.g., a default account, a of the recipient.

At step 402 of the method 400, a provider computing system (e.g., the provider computing system 102) receives a request to generate a digital token from a sender device (e.g., the sender device 106) of a sender. The request may identify one or more of an amount of a resource that is to be transferred, an identifier of a recipient, an identifier of a recipient device (e.g., the recipient device 108) of the recipient, a corresponding processing time value for the digital token, and an expiration time of the digital token. The processing time value may be a time value that corresponds to a date and time that the digital token may be processed using the techniques described herein, for example, to carry out a post-dated transfer of resource(s). The request may be transmitted via a client application (e.g., the client application circuit 146) executing on the sender device. The request may identify an account of the sender from which the transfer of the resource will be made.

At step 404 of the method 400, the provider computing system can verify authentication information for the digital token. As described herein, the provider computing system may, prior to generating the digital token, perform one or more authentication processes for the sender device and/or the recipient device. For example, the provider computing system may perform two-factor authentication, biometric authentication, contactless device authentication, among other types of authentication processes.

In some implementations, the provider computing system may perform two-factor authentication between the sender device and the recipient device to generate a digital token for a transfer of a resource. For example, upon receiving a request from the sender device to generate a digital token for the transfer, the provider computing system can generate and transit authentication information (e.g., a PIN, a code, a barcode, a QR code, etc.) to the recipient device. The recipient device can then display the authentication information to the sender, and the authentication information can be provided to the provider computing system via the sender device to complete authentication for generating the digital token.

If the provider computing system determines that the authentication information transmitted to the recipient device matches the authentication information received from the sender device, the provider computing system can determine that the authentication information for the digital token is verified and proceed to step 406 of the method 400. Otherwise, the provider computing system may transmit an error message to the sender device indicating authentication failed. Similar techniques may be performed to biometrically authenticate the sender and/or recipient. For example, the provider computing system may transmit requests for biometric information to the sender device and/or the recipient device to authenticate the sender and/or the recipient. The sender device and/or the recipient device may then capture and transmit the requested biometric information to the provider computing system, which can compare the received biometric data to previously stored biometric data for the sender and/or the recipient. Upon detecting a match, the provider computing system can determine that the authentication information for the digital token is verified and proceed to step 406 of the method 400. Otherwise, the provider computing system may transmit an error message to the sender device indicating authentication failed.

At step 406, the provider computing system can generate the digital token for transmission to the recipient user device. The digital token may be associated with the processing time value (e.g., a timestamp) identified in the request. To generate the digital token, the provider computing system can generate unique value, such as a unique fifteen-digit or fifteen-character alphanumeric code. In some implementations, the digital token can be generated or represented as a bar code, a QR code, or an encoded value that includes an arbitrary number of digits, characters, symbols, or values. In some implementations, the provider computing system can generate a digital token based on the information included in the request to generate the digital token. For example, the provider computing system may execute an encoding algorithm using one or more of the identifier of the sender device, the identifier of the recipient device, the expiration time of the digital token, the amount of the resource that the digital token is to represent, or the processing time value of the digital token, to generate the digital token.

At step 408 of the method 400, the provider computing system can transmit the generated digital token to the sender device and/or the sender device. To do so, the provider computing system may utilize the identifier of the recipient device identified in the request. The provider computing system may transmit the digital token in an electronic message, such as an email, a text message, a social media message, or via any other type of electronic transmission. In some implementations, the provider computing system may transmit the generated digital token to the sender device, which may then transmit the digital token to the recipient device via electronic communication or manual communication. In addition to transmitting the digital token, the provider computing system can store the digital token in a digital token database (e.g., the digital token database 121) in association with any information included in or derived from the request (e.g., an identifier of the sender or sender device, an identifier of the recipient or recipient device, an identifier of the request, etc.).

At step 410 of the method 400, the provider computing system can receive a request to process the digital token. The request to process the digital token may be a request to redeem the digital token or otherwise complete the transfer represented by the digital token. The request to process the digital token may be received from the recipient device or a transaction machine (e.g., the transaction machine 104). The transaction machine may be an ATM or a POS of a merchant. The request to process the digital token may include the digital token (e.g., the fifteen-digit or fifteen-character alphanumeric code, etc.). In some implementations, the request to process the digital token may designate a portion of the resource that is to be dispensed via the transaction machine. For example, the recipient may provide that a portion of the resource is to be dispensed via the transaction machine, and the remainder of the resource is to be credited to an account of the recipient. The account may be identified in the request, or may be automatically selected by the provider computing system.

At step 412 of the method 400, the provider computing system can determine whether the digital token identified in the request is valid. To do so, the provider computing system can access and search the digital token database to determine whether the digital token exists in the database. If the digital token does not exist, the provider computing system can execute step 414 and transmit an error to the device (e.g., the recipient device, the transaction machine) that requested processing of the digital token.

If the digital token exists, the provider computing system can determine whether the digital token is valid. A digital token may be considered invalid if it is expired or has been previously redeemed. In some implementations, if the digital token represents a post-dated transfer, the provider computing system can determine whether a current time falls after the processing time value stored in association with the digital token. If the processing time value has passed (e.g., the current time satisfies the requirements for the post-dated transfer), the provider computing system may proceed. If the digital token is valid (e.g., exists in the database, has not already been redeemed, has not expired, and the current time satisfies the processing time value of the digital token), the provider computing system can proceed to step 416 of the method 400. Otherwise, the provider computing system can proceed to step 414 of the method 400 to transmit an error to the device that transmitted the request to process the digital token.

At step 414 of the method 400, the provider computing system can transmit an error to the device that transmitted the request to process the digital token. The error message may indicate the reason(s) identified in step 412 that the digital token was determined to be invalid. The error message may include a prompt to re-transmit the request or correct an error. For example, if the digital token was requested to be processed before the processing time value associated with the digital token, the error message may indicate when the digital token may be processed. In another example, if the digital token has been previously processed or has expired, the error message may indicate that the digital token has been previously processed or has expired, respectively. In yet another example, if the digital token does not exist in the digital token database, the error message may indicate that the provider computing system has no record of the digital token.

At step 416 of the method 400, the provider computing system can transmit a request for authentication information for the digital token. The request may be transmitted to the recipient device identified as being associated with the digital token in the digital token database. The request for authentication information may be a request for any type of authentication information, including biometric information, two-factor authentication information, or authentication credentials.

In one example, the provider computing system may transmit a request for biometric data to the recipient device. In some implementations, the request for biometric authentication may be transmitted to the transaction machine if the request to process the digital token was received from the transaction machine. In response to the request, the recipient may provide the requested biometric information (e.g., fingerprint, picture of face or identifying physical feature, retinal scan, etc.) via the transaction machine and/or the recipient device, which can transmit the captured biometric information to the primary computing system.

In another example, the primary computing system may perform a two-factor authentication process. To do so, the primary computing system may generate two-factor authentication information (e.g., an alphanumeric code, a barcode, a QR code, etc.) that may be provided to the recipient device identified in the digital token database as associated with the digital token. Upon receipt, the recipient device can display the authentication information to the recipient, who can then provide (e.g., transmit, communicate, etc.) the authentication information to the transaction machine (if the transaction machine transmitted the request to process the digital token).

In another implementation, the two-factor information may be provided to the transaction machine, and subsequently entered into or otherwise provided to the recipient device, which can then transmit the two-factor authentication information to the primary computing system. In yet another implementation, the primary computing system can provide the two-factor authentication information to the recipient device identified as associated with the digital token. The recipient may provide the received two-factor authentication information as input to an application (e.g., the client application circuit 166) associated with the provider institution computing system and executing on the recipient device. The application can then transmit the received two-factor authentication information to the primary computing system for verification.

At step 418, the primary computing system can verify whether the received authentication information is valid. For example, if biometric authentication was requested, the primary computing system can utilize the received biometric information to biometrically authenticate the recipient, as described herein. If two-factor authentication information was transmitted, the primary computing system can compare the received two-factor authentication information (e.g., a six-digit or six-character alphanumeric code) to the corresponding transmitted two-factor authentication information. If the authentication information matches what is stored at the primary computing system, the primary computing system can proceed to perform step 422 of the method 400. Otherwise, the primary computing system can perform step 420 of the method 400 to indicate an error.

At step 420 of the method 400, the provider computing system can transmit an error to the device that transmitted the request to process the digital token. The error message may indicate that authentication failed, and may include a prompt to provide the authentication information again, or to utilize an alternative process for authentication. For example, if biometric authentication was requested and ultimately failed, two-factor authentication processes may be suggested in the prompt, and vice versa. In some implementations, upon transmitting the error, the primary computing system may initiate a timer that prevents processing of the digital token for a predetermined amount of time, to reduce instances of brute-force fraud attacks.

At step 422 of the method 400, the primary computing system can cause the transaction machine to provide the portion of the resource. For example, in an implementation where the request to process the digital token was received from the transaction machine, the primary computing system can, upon successfully authenticating the recipient in step 418, transmit a signal that indicates the transaction machine is authorized to dispense at least a portion of the resource represented by the digital token. The signal may include an indication of an amount represented by the digital token.

In an implementation where the request to process the token was received from the recipient device, the primary computing system can credit an account associated with the recipient with the amount identified in the digital token. The account may be identified in the request to process the digital token, or may be automatically identified based on information on the recipient stored at the provider computing system. For example, the primary computing system may perform a lookup in a database that maps identifiers of devices (e.g., the identifier of the recipient device) to accounts maintained by the provider computing system. If the identifier of the recipient device is associated with an account maintained by the provider computing system, the provider computing system can identify that account as the account to credit. In some implementations, the provider computing system may transmit a request to the recipient device or the transaction machine to specify which account of the recipient to transfer the resource (or the remainder of the resource). The recipient may identify and transmit an identifier of the account in response to the request.

At step 424, the primary computing system can credit a remainder of the resource to an account associated with the second user. As described herein, in certain situations, the transaction machine may dispense a portion of the resource represented by the digital token. Upon doing so, the transaction machine can transmit an indication that a portion of the resource has been dispensed. The primary computing system can then credit a remainder of the amount of the resource not dispensed via the transaction machine to an account of the recipient. The account may be identified in the request to process the digital token, automatically selected by the provider computing system, or provided in response to a request transmitted by the provider computing system, as described herein. When crediting and/or dispensing the resource, an account of the sender may be debited by the amount of the resource represented by the digital token to complete the transfer of the resource from the sender to the recipient.

The implementations described herein have been described with reference to drawings. The drawings illustrate certain details of specific implementations that implement the systems, methods, and programs described herein. However, describing the implementations with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more general-purpose processors, ASICs, FPGAs, digital signal processors (DSPs), or other suitable electronic data processing components structured to execute instructions provided by memory. The one or more processors may take the form of a single core processor, multi-core processor (e.g., a dual core processor, triple core processor, and/or quad core processor), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the implementations might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data, which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions and implementation of the implementations without departing from the scope of the present disclosure as expressed in the appended claims.

What is claimed is:

1. A system, comprising:
a provider institution computing system comprising one or more processors and at least one non-transitory memory, the provider institution computing system configured to:
receive, from a first user device associated with a first user, a first request to generate a digital token representing a transfer of a resource to a second user, the first request comprising an identifier of a second user device associated with the second user;
upon verifying authentication information received from the first user device, generate the digital token for transmission to the second user device, the digital token associated with a usage timestamp;
receive, from a transaction machine associated with the provider institution computing system, a second request to redeem the digital token, the second request designating a portion of the resource;
responsive to determining that the second request to redeem the digital token is valid, cause the transaction machine to provide the portion of the resource; and
credit a remainder of the resource to an account associated with the second user.

2. The system of claim 1, wherein the authentication information includes an authentication code, and wherein the provider institution computing system is further configured to:
generate the authentication code in response to the first request; and
transmit the authentication code to the second user device.

3. The system of claim 2, wherein the provider institution computing system is further configured to determine that the second request to redeem the digital token is valid based on a comparison of a current time to the usage timestamp.

4. The system of claim 1, wherein the transaction machine includes an automated teller machine (ATM), and the provider institution computing system is further configured to:
receive, from the ATM associated with the provider institution computing system, a third request to redeem a second digital token, the second digital token associated with a second usage timestamp; and
transmit, to the ATM for display, an error message responsive to determining that the second digital token is not valid based on the second usage timestamp.

5. The system of claim 1, wherein the provider institution computing system is further configured to:
generate a second authentication code for transmission to the second user device in response to receiving the second request; and
verify the second request to redeem the digital token based on the second authentication code and a message received from the transaction machine.

6. The system of claim 1, wherein the provider institution computing system is further configured to:
authenticate the second user based on biometric information provided via the transaction machine.

7. The system of claim 1, wherein the provider institution computing system is further configured to:
identify the account associated with the second user based on the identifier of the second user device of the second user.

8. The system of claim 1, wherein the transaction machine includes an automated teller machine (ATM), and wherein the provider institution computing system is further configured to cause the ATM to dispense the portion of the resource responsive to determining that the second request to redeem the digital token is valid.

9. The system of claim 1, wherein the digital token is associated with an expiration timestamp, and wherein the provider institution computing system is further configured to:
determine that the digital token is valid based on a current timestamp being prior to the expiration timestamp.

10. The system of claim 1, wherein the provider institution computing system comprises a digital token database including a mapping between the digital token and the transfer of the resource from the first user to the second user.

11. A non-transitory computer-readable medium with instructions embodied thereon that, when executed by one or more processors of a provider institution computing system of a provider institution, cause the one or more processors to perform operations comprising:
receiving, from a first user device associated with a first user, a first request to generate a digital token representing a transfer of a resource to a second user, the first request comprising an identifier of a second user device associated with the second user;
upon verifying authentication information received from the first user device, generating the digital token for transmission to the second user device, the digital token associated with a usage timestamp;
receiving, from a transaction machine associated with the provider institution computing system, a second request to redeem the digital token, the second request designating a portion of the resource;
responsive to determining that the second request to redeem the digital token is valid, causing the transaction machine to provide the portion of the resource; and
crediting a remainder of the resource to an account associated with the second user.

12. The non-transitory computer-readable medium of claim 11, wherein the instructions, when executed, cause the one or more processors to perform further operations comprising:
transmitting a request for biometric data to the second user device;
receiving, responsive to the request for biometric data, biometric information of the second user from the second user device; and
authenticating the second user based on the biometric information.

13. The non-transitory computer-readable medium of claim 12, wherein the instructions, when executed, cause the one or more processors to perform further operations comprising determining that the second request to redeem the digital token is valid is responsive to authenticating the second user.

14. The non-transitory computer-readable medium of claim 11, wherein the authentication information comprises an authentication code, and wherein the instructions, when executed, cause the one or more processors to perform further operations comprising:
generating the authentication code in response to the first request; and
transmitting the authentication code to the second user device.

15. The non-transitory computer-readable medium of claim 11, wherein the instructions, when executed, cause the one or more processors to perform further operations comprising:
receiving, from the transaction machine associated with the provider institution computing system, a third request to redeem a second digital token.

16. The non-transitory computer-readable medium of claim 15, wherein the second digital token is associated with a second usage timestamp, and wherein the instructions, when executed, cause the one or more processors to perform further operations comprising:
determining that the second digital token is not valid based on the second usage timestamp; and
transmitting, to the transaction machine for display, an error message responsive to determining that the second digital token is not valid based on the second usage timestamp.

17. The non-transitory computer-readable medium of claim 15, wherein the third request comprises second biometric data of the second user, and wherein the instructions, when executed, cause the one or more processors to perform further operations comprising:
determining that the third request is not valid based on the second biometric data of the second user; and
transmitting, to the transaction machine for display, an error message responsive to determining that the third request is not valid.

18. A method, comprising:
receiving, by at least one computing system, from a first user device associated with a first user, a first request to generate a digital token representing a transfer of a resource to a second user, the first request comprising an identifier of a second user device associated with the second user;
upon verifying authentication information received from the first user device, generating, by the at least one computing system, the digital token for transmission to the second user device, the digital token associated with a usage timestamp;
receiving, by the at least one computing system, from a transaction machine associated with the at least one computing system, a second request to redeem the digital token, the second request designating a portion of the resource;
responsive to determining that the second request to redeem the digital token is valid, causing, by the at least one computing system, the transaction machine to provide the portion of the resource; and
crediting, by the at least one computing system, a remainder of the resource to an account associated with the second user.

19. The method of claim 18, wherein the authentication information comprises an authentication code, the method further comprising:
generating, by the at least one computing system, the authentication code in response to the first request; and
transmitting, by the at least one computing system, the authentication code to the second user device.

20. The method of claim 18, wherein determining that the second request to redeem the digital token is valid is further based on a comparison of a current time to the usage timestamp.
